(19) United States
(12) Patent Application Publication
(10) Pub. No.: US 2021/0292961 A1
(43) Pub. Date: Sep. 23, 2021

(54) WASHING MACHINE FILTRATION BASED ON FABRIC COMPOSITION

(71) Applicant: Haier US Appliance Solutions, Inc., Wilmington, DE (US)

(72) Inventor: James Quentin Pollett, Louisville, KY (US)

(21) Appl. No.: 16/822,218

(22) Filed: Mar. 18, 2020

(51) Int. Cl. D06F 39/10; C02F 1/00; D06F 33/42

(52) U.S. Cl. CPC D06F 39/10; C02F 1/001; C02F 2103/002; D06F 33/42; C02F 1/008

(57) ABSTRACT

A washing machine appliance and a method for operating a washing machine appliance are provided. The washing machine appliance includes a tub and a drum rotatably mounted within the tub. The drum defines a wash chamber for receipt of articles for washing. The washing machine appliance also includes a controller. The controller is configured for and/or the method includes selectively filtering a flow of wash liquid from the tub, automatically based on determining a load type of articles within the wash chamber and/or based on a received user input.

### FIELD OF THE INVENTION

The present subject matter relates generally to washing machine appliances and methods for operating washing machine appliances.

### BACKGROUND OF THE INVENTION

Washing machine appliances generally include a tub for containing wash liquid, e.g., water, detergent, and/or bleach, during operation of such washing machine appliances. A drum is rotatably mounted within the tub and defines a wash chamber for receipt of articles for washing. During operation of such washing machine appliances, wash liquid is directed into the tub and onto articles within the wash chamber of the drum. The drum can rotate at various speeds to agitate articles within the wash chamber in the wash liquid, to wring wash liquid from articles within the wash chamber, etc.

During operating of certain washing machine appliances, a volume of water is directed into the tub in order to form wash liquid and/or rinse articles within the wash chamber of the drum. The volume of water can vary depending upon a variety of factors. Large loads can require a large volume of water relative to small loads that can require a small volume of water. Likewise, loads containing absorptive fabrics, such as cotton, can require a large volume of water relative to similarly sized loads containing certain synthetic fabrics, such as polyester or nylon.

The wash liquid is drained from the tub, e.g., after a wash cycle or at the end of the wash cycle, and directed into a wastewater system. The drained wash fluid or effluent from the washing machine appliance often ultimately reaches waterways. Such effluent may contain fibers from the articles. In particular, it may be desirable to avoid or minimize synthetic fibers in waterways.

Accordingly, a method for operating a washing machine appliance that can assist with determining a load type of articles within the wash chamber of the drum and selectively filtering effluent from the drum based on the load type would be useful.

### BRIEF DESCRIPTION OF THE INVENTION

Aspects and advantages of the invention will be set forth in part in the following description, or may be apparent from the description, or may be learned through practice of the invention.

In one exemplary embodiment, a method of operating a washing machine appliance is provided. The washing machine appliance has a drum positioned within a tub. The drum defines a wash chamber for receipt of articles for washing. The method includes determining a load type of articles within the wash chamber of the drum based on mass of the articles and absorbency of the articles. The method also includes flowing a wash liquid from the tub and selectively automatically filtering the flow of wash liquid based on the determined load type.

In another exemplary embodiment, a method of operating a washing machine appliance is provided. The washing machine appliance includes a tub and a drum rotatably mounted within the tub. The drum defines a wash chamber for receipt of articles for washing. The method includes receiving a user input, flowing a wash liquid from the tub, and selectively filtering the flow of wash liquid based on the user input.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a washing machine appliance according to an exemplary embodiment of the present subject matter.

FIG. 2 provides a front, section view of the exemplary washing machine appliance of FIG. 1.

FIG. 3 illustrates a schematic of various components of the exemplary washing machine appliance of FIG. 1 according to an exemplary embodiment of the present subject matter.

FIG. 4 illustrates a schematic of various components of the exemplary washing machine appliance of FIG. 1 according to an additional exemplary embodiment of the present subject matter.

FIG. 5 illustrates a method of operating a washing machine appliance according to an exemplary embodiment of the present subject matter.

FIG. 6 illustrates a method of operating a washing machine appliance according to another exemplary embodiment of the present subject matter.

FIG. 7 illustrates a method of operating a washing machine appliance according to yet another exemplary embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

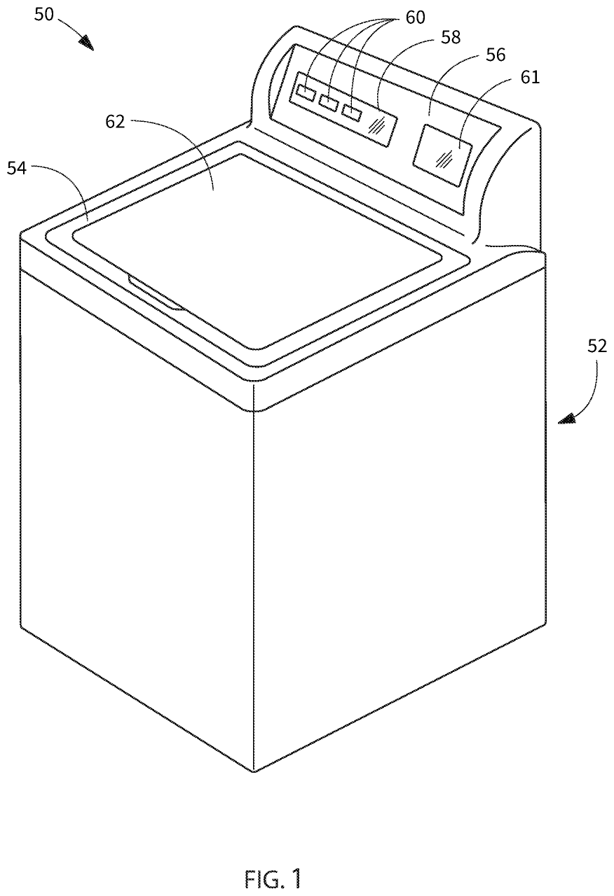

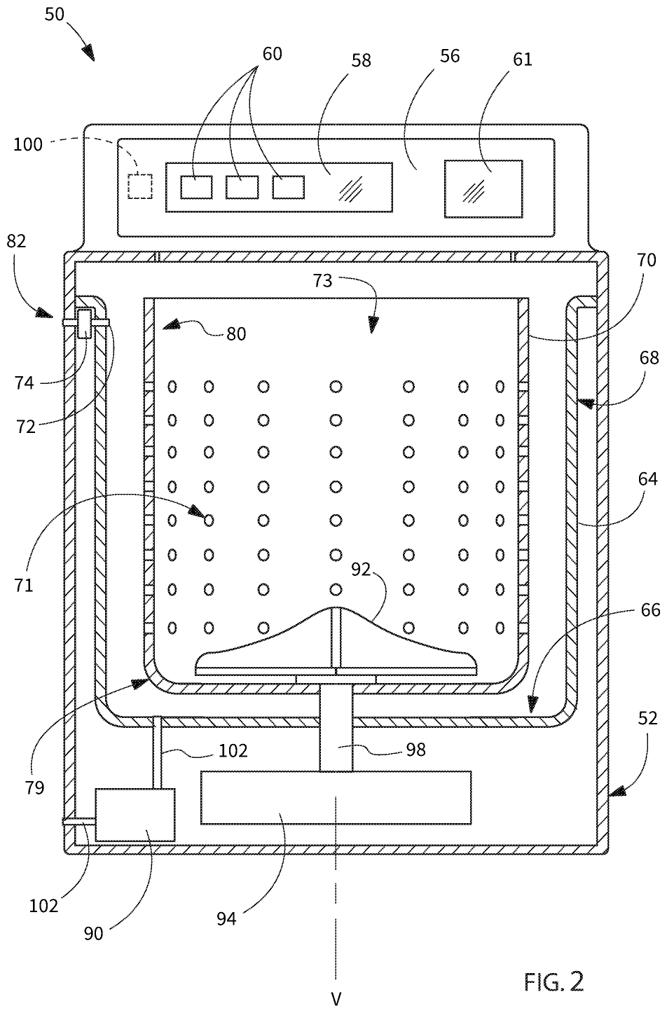

FIG. 1 is a perspective view of a washing machine appliance 50 according to an exemplary embodiment of the present subject matter. As may be seen in FIG. 1, washing machine appliance 50 includes a cabinet 52 and a cover 54. A backsplash 56 extends from cover 54, and a control panel 58 including a plurality of input selectors 60 is coupled to backsplash 56. Control panel 58 and input selectors 60 collectively form a user interface input for operator selection of machine cycles and features, and in one embodiment, a display 61 indicates selected features, a countdown timer, and/or other items of interest to machine users. A lid 62 is mounted to cover 54 and is rotatable between an open position (not shown) facilitating access to a wash tub 64 (FIG. 2) located within cabinet 52 and a closed position (shown in FIG. 1) forming an enclosure over wash tub 64.

FIG. 2 provides a front, cross-section view of washing machine appliance 50. As may be seen in FIG. 2, wash tub 64 includes a bottom wall 66 and a sidewall 68. A wash basket 70 is rotatably mounted within wash tub 64. In particular, wash basket 70 is rotatable about a vertical axis V. Thus, washing machine appliance is generally referred to as a vertical axis washing machine appliance. Wash basket 70 defines a wash chamber 73 for receipt of articles for washing and extends, e.g., vertically, between a bottom portion 79 and a top portion 80. Wash basket 70 includes a plurality of perforations 71 therein to facilitate fluid communication between an interior of wash basket 70 and wash tub 64.

A spout 72 is configured for directing a flow of fluid into wash tub 64. In particular, spout 72 may be positioned at or adjacent top portion 80 of wash basket 70. Spout 72 may be in fluid communication with a water supply (not shown) in order to direct fluid (e.g., clean water) into wash tub 64 and/or onto articles within wash chamber 73 of wash basket 70. A valve 74 regulates the flow of fluid through spout 72. For example, valve 74 can selectively adjust to a closed position in order to terminate or obstruct the flow of fluid through spout 72. A pump assembly 90 (shown schematically in FIG. 2) is located beneath tub 64 and wash basket 70 for gravity assisted flow from wash tub 64. Pump 90 may be positioned along or in operative communication with a drain line 102 which provides fluid communication from the wash chamber 73 of the basket 70 to an external conduit, such as a wastewater line (not shown). In some embodiments, the pump 90 may also or instead be positioned along or in operative communication with a recirculation line (not shown) which extends back to the tub 64, e.g., in addition to the drain line 102.

An agitation element 92, shown as an impeller in FIG. 2, is disposed in wash basket 70 to impart an oscillatory motion to articles and liquid in wash chamber 73 of wash basket 70. In various exemplary embodiments, agitation element 92 includes a single action element (i.e., oscillatory only), double action (oscillatory movement at one end, single direction rotation at the other end) or triple action (oscillatory movement plus single direction rotation at one end, single direction rotation at the other end). As illustrated in FIG. 2, agitation element 92 is oriented to rotate about vertical axis V. Wash basket 70 and agitation element 92 are driven by a pancake motor 94. As motor output shaft 98 is rotated, wash basket 70 and agitation element 92 are operated for rotatable movement within wash tub 64, e.g., about vertical axis V. Washing machine appliance 50 may also include a brake assembly (not shown) selectively applied or released for respectively maintaining wash basket 70 in a stationary position within wash tub 64 or for allowing wash basket 70 to spin within wash tub 64.

Operation of washing machine appliance 50 is controlled by a processing device or controller 100, that is operatively coupled to the user interface input located on washing machine backsplash 56 for user manipulation to select washing machine cycles and features. In response to user manipulation of the user interface input, controller 100 operates the various components of washing machine appliance 50 to execute selected machine cycles and features.

Controller 100 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 100 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Control panel 58 and other components of washing machine appliance 50 may be in communication with controller 100 via one or more signal lines or shared communication busses.

In an illustrative embodiment, laundry items are loaded into wash chamber 73 of wash basket 70, and washing operation is initiated through operator manipulation of control input selectors 60. Wash tub 64 is filled with water and mixed with detergent to form a wash fluid. Valve 74 can be opened to initiate a flow of water into wash tub 64 via spout 72, and wash tub 64 can be filled to the appropriate level for the amount of articles being washed. Once wash tub 64 is properly filled with wash fluid, the contents of the wash basket 70 are agitated with agitation element 92 for cleaning of laundry items in wash basket 70. More specifically, agitation element 92 is moved back and forth in an oscillatory motion. The wash fluid may be recirculated through the washing machine appliance 50 at various points in the wash cycle, such as before or during the agitation phase (as well as one or more other portions of the wash cycle, separately or in addition to before and/or during the agitation phase).

After the agitation phase of the wash cycle is completed, wash tub 64 is drained. Laundry articles can then be rinsed by again adding fluid to wash tub 64, depending on the particulars of the cleaning cycle selected by a user, agitation element 92 may again provide agitation within wash basket 70. One or more spin cycles may also be used. In particular, a spin cycle may be applied after the wash cycle and/or after the rinse cycle in order to wring wash fluid from the articles being washed. During a spin cycle, wash basket 70 is rotated at relatively high speeds. In various embodiments, the pump 90 may be activated to drain liquid from the washing machine appliance 50 during the entire drain phase (or the entirety of each drain phase, e.g., between the wash and rinse and/or between the rinse and the spin) and may be activated during one or more portions of the spin cycle.

While described in the context of a specific embodiment of washing machine appliance 50, using the teachings disclosed herein it will be understood that washing machine appliance 50 is provided by way of example only. Other washing machine appliances having different configurations (such as horizontal-axis washing machine appliances), different appearances, and/or different features may also be utilized with the present subject matter as well.

Throughout the wash cycle, various outflows from the tub 64 are generated. Such outflows may be directed to the drain line 102 immediately after flowing from the tub 64, or may be recirculated through the tub 64 one or more times prior to ultimately being drained from the washing machine appliance 50. Fabric particles may be entrained in this effluent. Depending at least in part on the composition of the articles from which the particles originated, the particles entrained in the effluent may present an environmental concern. For example, natural fiber particles generally biodegrade relatively easily and, as such, are of minimal environmental concern. In contrast, synthetic fiber particles, e.g., polyester particles, may be relatively more persistent in receiving waterways downstream of the washing machine appliance 50, whereby some consumers may desire to avoid or minimize releasing such particles in the effluent from the washing machine appliance 50.

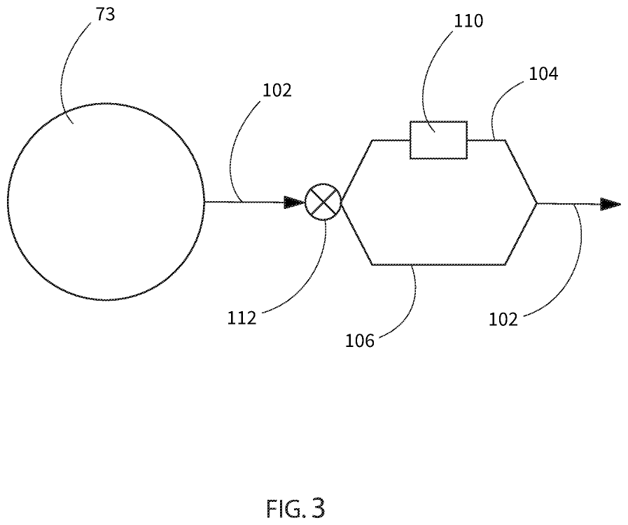

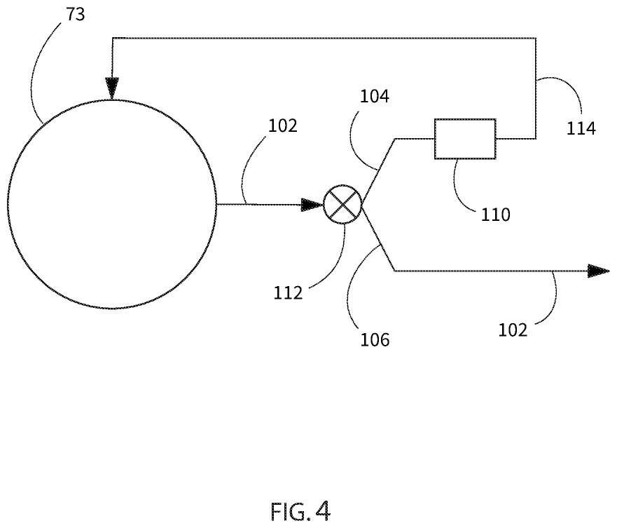

Thus, turning now to FIGS. 3 and 4, in some embodiments, the washing machine appliance 50 may include or be connected to a filter 110 which removes entrained fabric particles from effluent flowing from the washing machine 50. For example, the filter 110 may be internal to the washing machine appliance 50, e.g., may be disposed within the cabinet 52, or may be external to the washing machine appliance 50. As generally shown in FIG. 3, the filter 110 may be in fluid communication with the drain line 102, e.g., the filter 110 may be positioned in or along the drain line 102, such as in a branch of the drain line 102. Thus, it should be understood that the filter 110 is in fluid communication with the drain line 102 in that the filter receives a flow of fluid, such as effluent, from the drain line 102, such as from an upstream end thereof, and that the filter 110 provides a flow of fluid to the drain line 102, such as a downstream portion of the drain line 102. In other embodiments, as illustrated in FIG. 4, the filter 110 may return the flow of fluid to the wash tub 73, e.g., the wash fluid may be recirculated via a recirculation line 114, and the flow of fluid may flow to the downstream portion of the drain line 102 only indirectly from the filter 110, e.g., via the wash tub 73. As mentioned, the filter 110 may be positioned in a branch of the drain line 102. For example, the drain line 102 may include or be connected to a filter line 104 including the filter 110 and a bypass line 106 which extends around the filter 110 and is not in direct fluid communication with the filter 110. A diverter valve 112 may be provided and may be configured to selectively provide or direct a flow of fluid, e.g., effluent or drained wash liquid, to one of the branches 104 or 106. Thus, the washing machine appliance 50 may be configured for, and exemplary methods may include, selectively filtering the effluent based on the position of the diverter valve 112. Such selective filtration may be automatic, e.g., in response to a determined load type, or may be based on a user input which may be received, e.g., from one or more of the input selectors 60. For example, the controller 100 may be operatively connected to the diverter valve 112 and may be configured for moving or actuating the diverter valve 112 such that the diverter valve 112 directs the flow of fluid from the wash chamber 73 and/or the drain line 102 to one or the other of the filter line 104 and the bypass line 106. Further, in some additional example embodiments, the filter 110 may be positioned in or along the recirculation line 114 as well as or instead of the drain line 102. For example, as illustrated in FIG. 4, the recirculation line 114 may lead back to the tub 64 rather than to the drain line 102, such that the diverter valve 112 may selectively direct the flow of fluid from the wash chamber 73 through the filter 110 and then back to the tub 64 or through the bypass line 106 and then to the downstream portion of the drain line 102. As another example, a second diverter valve may be provided downstream of the filter 110 to selectively direct the flow of filtered fluid from the filter 110 back to the tub 64 or to the drain line 102.

Over time, the filter 110 may become fouled and require cleaning to remove the trapped fabric particles from the filter 110. In particular, natural fabric articles, such as cotton fiber articles, generate entrained fiber particles in the washing machine effluent at a higher rate than synthetic fabric articles. Therefore, filtering effluent from loads including all or mostly natural fiber articles may lead to more frequent fouling of the filter 110 and may lead to more frequent cleaning of the filter 110 and/or higher wear and tear on the filter 110, even though there is less of a concern with removing natural fibers from the effluent. Accordingly, methods of operating the washing machine appliance 50 may include and/or the washing machine appliance 50 may be configured for selectively filtering the effluent, e.g., a flow of wash liquid from the tub 64. For example, in various embodiments, the wash liquid may be filtered based on a load type of articles in the wash chamber and/or based on a user input.

For example, exemplary methods may include determining the load type of articles in the wash chamber and/or the controller 100 may be configured to determine a load type of articles within wash chamber 73 of basket 70. For example, other exemplary methods of establishing a load type are described in U.S. Pat. No. 9,758,913 to Obregon, the disclosure of which is incorporated herein by reference in its entirety for all purposes.

As used herein, the term “load type” corresponds to a composition or fabric type of articles, e.g., within wash chamber 73 of basket 70. As an example, the load type of such articles may be natural, synthetic, or blended. A natural load type may include entirely or predominantly articles composed of natural fiber fabrics, such as cotton. A synthetic load type may include synthetic articles, such as nylon or polyester articles. If a mixed or blended load of articles is disposed within wash chamber 73 of basket 70, the load type of such articles is a mixed or blended load type. Thus, the blended load type can correspond to a blend of cotton articles and synthetic articles within wash chamber 73 of basket 70.

The load type of articles within wash chamber 73 of basket 70 may be determined at least in part based on mass of the articles and the absorptivity of the articles. For example, natural articles such as cotton articles can have a relatively high absorptivity whereas synthetic articles, such as nylon or polyester articles, can have a relatively low absorptivity. Determining the load type may include rotating basket 70 with motor 94, e.g., by the controller 100. Thus, controller 100 can activate motor 94 in order to rotate basket 70. Controller 100 can operate motor 94 such that basket 70 rotates at a predetermined frequency or angular velocity. The predetermined frequency or angular velocity can be any suitable frequency or angular velocity. For example, the predetermined frequency or angular velocity may be about one hundred and twenty revolutions per minute.

The controller 100 may also adjust an angular velocity of basket 70. Controller 100 can utilize motor 94 to adjust the angular velocity of basket 70. In certain exemplary embodiments, controller 100 can deactivate motor 94 in order to adjust the angular velocity of basket 70. To deactivate motor 94, controller 100 can short windings of motor 94, e.g., using any suitable mechanism or method known to those skilled in the art.

Determining the load type may further include, by the controller 100, determining an angular acceleration or first derivative of the angular velocity of basket 70 or a jerk or a second derivative of the angular velocity of basket 70, e.g., based at least in part the adjustment of the angular velocity of basket 70. Based upon the first and/or second derivative of the angular velocity of basket 70, controller 100 estimates a mass of articles within wash chamber 73 of basket 70. Thus, controller 100 can establish the mass of articles within wash chamber 73 of basket 70 based upon the inertia of articles within wash chamber 73 of basket 70. As an example, the magnitude of the first and/or second derivative of the angular velocity of basket 70 can be inversely proportional to the mass of articles within wash chamber 73 of basket 70. Thus, controller 100 can correlate the magnitude of the first and/or second derivative of the angular velocity of basket 70 to the mass of articles within wash chamber 73 of basket 70. The controller 100 can also establish a tolerance range for the mass of articles within wash chamber 73 of basket 70. The tolerance range for the mass of articles within wash chamber 73 of basket 70 can correspond to the error or uncertainty of the estimate of the mass of articles within wash chamber 73 of basket 70.

Determining the load type may also include directing a volume of liquid into wash tub 64, e.g., by the controller 100. In particular, controller 100 may direct liquid into wash tub 64 until a level of liquid within wash tub 64 reaches a predetermined height, e.g., about six inches. The predetermined height may be detected or confirmed based on a pressure sensor in some embodiments. As an example, controller 100 can open valve 74 in order to direct a flow of liquid into wash tub 64. After or when the level of liquid within wash tub 64 reaches the predetermined height, controller 100 can close valve 74 in order to terminate the flow of liquid into wash tub 64. Controller 100 can calculate the volume of liquid within wash tub 64, e.g., based on a flow rate of liquid through valve 74 and a time period between controller 100 opening and closing valve 74 or with the use of a liquid flow meter (not shown).

The controller 100 may then establish the load type of articles within wash chamber 73 of basket 70, e.g., based at least in part on the estimated mass of articles within wash chamber 73 of basket 70 and the calculated volume of liquid.

Additionally, the absorptivity of the articles may be determined based on the volume of liquid, for example by using one or more predetermined volume-liquid level absorption correlations for various load types of articles within wash chamber 73 of basket 70 and the estimated mass of articles within wash chamber 73 of basket 70. As used herein, the term “volume-liquid level absorption correlation” corresponds to a relationship between the volume of liquid within wash tub 64 required to fill wash tub 64 to the predetermined height and the mass of articles within wash chamber 73 of basket 70. As an example, if articles within wash chamber 73 of basket 70 have a relatively high absorptivity, a relatively large volume of liquid can be required to fill wash tub 64 to the predetermined height. Conversely, for a load with an identical mass as the above example, a relatively small volume of liquid can be required to fill wash tub 64 to the predetermined height if articles within wash chamber 73 of basket 70 have a relatively low absorptivity. If a blended load of articles is disposed within wash chamber 73 of basket 70, a volume of liquid between the relatively large volume of liquid and the relatively small volume of liquid can be required to fill wash tub 64 to the predetermined height.

In some embodiments, controller 100 can provide the plurality of liquid volume-liquid level absorption correlations. For example, the plurality of liquid volume-liquid level absorption correlations can be established experimentally and may be stored in the memory of controller 100 during production of washing machine appliance 50. Each absorption correlation of the plurality of liquid volume-liquid level absorption correlations corresponds to a respective load type of articles within wash chamber 73 of basket 70. In some exemplary embodiments, the plurality of liquid volume-liquid level absorption correlations may include a cotton liquid volume-liquid level absorption correlation and a blended liquid volume-liquid level absorption correlation.

In some embodiments, controller 100 can also ascertain predicted masses of articles within wash chamber 73 of basket 70 based at least in part on the plurality of liquid volume-liquid level absorption correlations. Each predicted mass of the predicted masses of articles within wash chamber 73 of basket 70 may correspond to a respective one of the plurality of liquid volume-liquid level absorption correlations.

In some embodiments, controller 100 can also compare the estimated mass of articles within wash chamber 73 of basket 70 and the predicted masses of articles within wash chamber 73 of basket 70 (the estimated mass may be estimated, for example, based on the first and/or second derivative of the angular velocity of basket 70, as described above). In particular, controller 100 can determine differences between the estimated mass of articles within wash chamber 73 of basket 70 and the predicted masses of articles within wash chamber 73 of basket 70. Controller 100 can establish the load type of articles within wash chamber 73 of basket 70 based at least in part on the differences between the estimated mass of articles within wash chamber 73 of basket 70 and the predicted masses of articles within wash chamber 73 of basket 70.

In some embodiments, controller 100 can select a cotton load type, a blended load type, or a synthetic load type based at least in part on differences between the estimated mass of articles within wash chamber 73 of basket 70 and the predicted masses of articles within wash chamber 73 of basket 70. The differences between the estimated mass and the predicted masses may fall within a tolerance range of the mass of articles within wash chamber 73 of basket 70 for one of the possible load types, e.g., the differences between the estimated mass and the predicted masses may fall within the tolerance range of the predicted mass of articles within wash chamber 73 of basket 70 for one of the natural load type, the synthetic load type, or the blended load type.

In some embodiments, if any portion of the tolerance range of the mass of articles within wash chamber 73 of basket 70 is within the tolerance range of the predicted mass of articles within wash chamber 73 of basket 70 for the blended load type, controller 100 can establish the load type of articles within wash chamber 73 of basket 70 as the blended load type. Conversely, if the tolerance range of the mass of articles within wash chamber 73 of basket 70 is only within the tolerance range of the predicted mass of articles within wash chamber 73 of basket 70 for the natural load type, controller 100 can establish the load type of articles within wash chamber 73 of basket 70 as the natural load type. Similarly, if the entire tolerance range of the mass of articles within wash chamber 73 of basket 70 is greater than the tolerance range of the predicted mass of articles within wash chamber 73 of basket 70 for the blended load type, controller 100 can establish the load type of articles within wash chamber 73 of basket 70 as the synthetic load type.

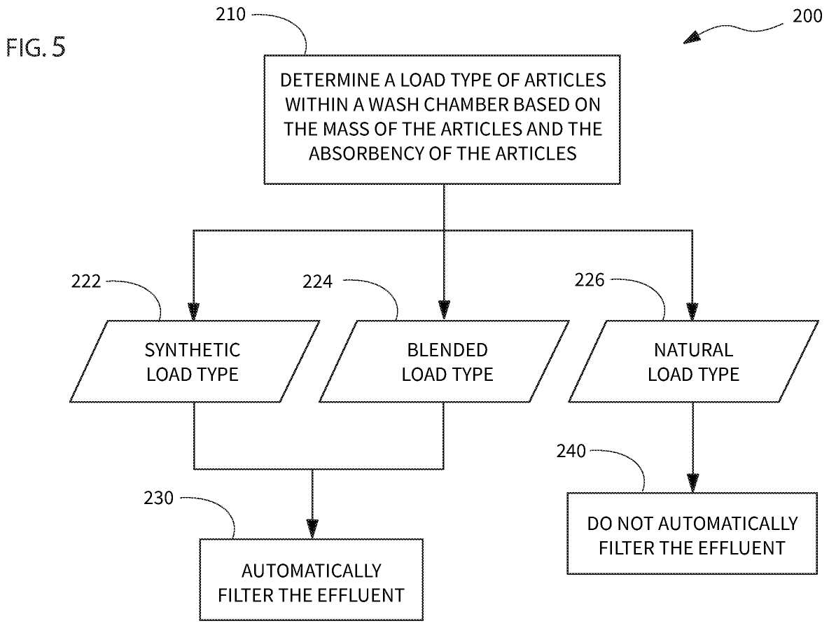

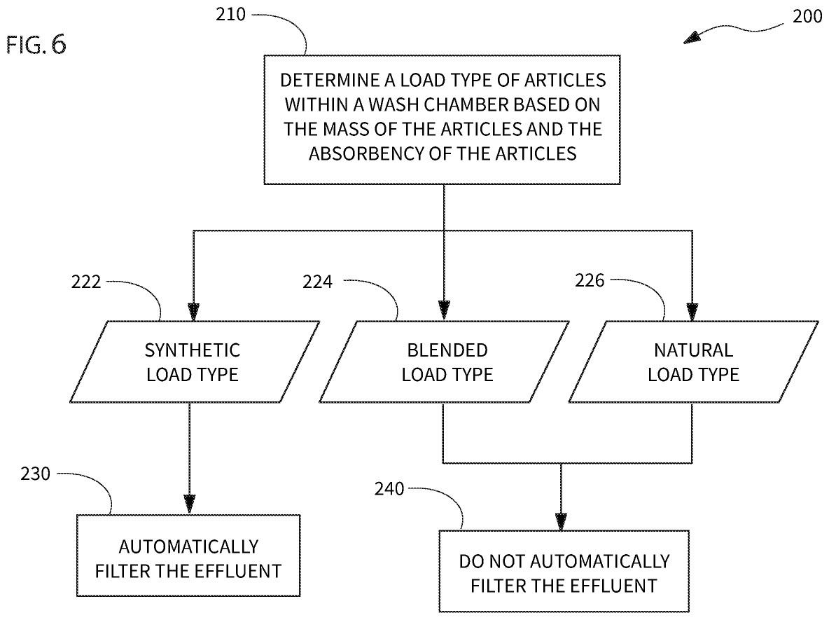

FIGS. 5 and 6 illustrate alternate example embodiments of a method 200 of operating a washing machine appliance according to the present subject matter. Method 200 can be used to operate any suitable washing machine appliance, such as washing machine appliance 50 (FIG. 1). Method 200 may be programmed into and implemented by controller 100 (FIG. 2) of washing machine appliance 50. Utilizing method 200, controller 100 may determine a load type of articles within wash chamber 73 of basket 70 and may selectively automatically filter effluent from the washing machine appliance 50 based on the determined load type.

At step 210, method 200 includes and/or controller 100 is configured for determining a load type of articles within the wash chamber of the drum based on the mass of the articles and the absorbency of the articles. Additionally, it should be understood that method 200 also includes flowing a wash liquid from the tub, e.g., producing effluent from the washing machine appliance, which may be directed to a drain from the washing machine appliance and/or may be recirculated within the washing machine appliance, such as back to the tub 64, although such step is not specifically illustrated. Method 200 may further include selectively automatically filtering the flow of wash liquid, i.e., effluent, based on the determined load type as determined at step 210.

In some embodiments, the determining step 210 of method 200 may result in an output, such as one of multiple possible outputs. In some embodiments, the output may be one of two possible outputs, e.g., either natural load type or synthetic load type. In some embodiments, as illustrated in FIGS. 5 and 6, the determining step 210 may lead to one of three possible outputs, a synthetic load type, e.g., at 222, a blended load type, e.g., at 224, and a natural load type, e.g., at 226. The natural load type may correspond to a load that is at least about seventy percent (70%) natural fibers or more, such as about eighty percent (80%) natural fibers or more, such as about ninety percent (90%) natural fibers or more, up to and including one hundred percent (100%) natural fibers. The synthetic load type may correspond to a load that is at least about seventy percent (70%) synthetic fibers or more, such as about eighty percent (80%) synthetic fibers or more, such as about ninety percent (90%) synthetic fibers or more, up to and including one hundred percent (100%) synthetic fibers. In embodiments which include the blended load type, the blended load type may correspond to between about ten percent (10%) synthetic fibers and about seventy percent (70%) synthetic fibers, such as between about between about twenty percent (20%) synthetic fibers and about sixty percent (60%) synthetic fibers. In additional embodiments, the minimum threshold of synthetic fibers for a blended load type may be about thirty percent (30%) synthetic fibers or more, such as about forty percent (40%) synthetic fibers.

When the load type is synthetic, e.g., when the output of step 210 includes synthetic load type 222, the method 200 may then proceed to automatically filtering the effluent at step 230, as illustrated in FIGS. 5 and 6. For example, in some embodiments, automatically filtering the effluent may include positioning or actuating the diverter valve 112 to direct the drained wash fluid into and through the filter line 104 and the filter 110 (FIG. 3 or FIG. 4). When the load type is natural, e.g., when the output of step 210 includes natural load type 226, the method 200 may then proceed to not automatically filtering the effluent at step 240, as illustrated in FIGS. 5 and 6. For example, not automatically filtering the effluent may include positioning or actuating the diverter valve 112 to direct the drained wash fluid into and through the bypass line 106 (FIG. 3 or FIG. 4).

Further, in various embodiments, the method 200 may include automatically filtering the effluent when the load type is blended (FIG. 5) or may include not automatically filtering the effluent when the load type is blended (FIG. 6). For example, as illustrated in FIG. 5, in some embodiments, when the load type is blended, e.g., when the output of step 210 includes blended load type 224, the method 200 may then proceed to automatically filtering the effluent at step 230, as illustrated in FIG. 5. As another example, in some embodiments, when the load type is blended, e.g., when the output of step 210 includes blended load type 224, the method 200 may then proceed to not automatically filtering the effluent at step 240, as illustrated in FIG. 6.

Additionally, in some embodiments, the washing machine appliance may also be configured for and/or the method may also include filtering the drained wash liquid in response to a user input when the drained wash liquid is not automatically filtered. For example, the plurality of input selectors 60 (FIG. 2) may include a cycle selector and/or a filtration selector. Thus, in some embodiments, the user input in response to which the effluent is filtered may include a selected cycle of the washing machine appliance. For example, when the selected cycle is a cotton cycle, the effluent may not be filtered, whereas, the effluent may be filtered, e.g., directed to the filter 110 by the diverter valve 112 (FIG. 3 or FIG. 4), when the selected cycle is a synthetics cycle. In various embodiments, the synthetics cycle may be explicitly denominated as a synthetics cycle, or the selected may include one or more additional cycles which are associated with a synthetic fabric, such as an Active Wear cycle, a Sports Wear cycle, etc., instead of or in addition to the more general synthetics cycle. In at least some embodiments, the effluent may also be filtered in response to a user selection that includes or corresponds to a blended cycle. Additionally, the user input in response to which the effluent is filtered may also or instead include a manual filtration input, e.g., such as a filtration mode or option selector.

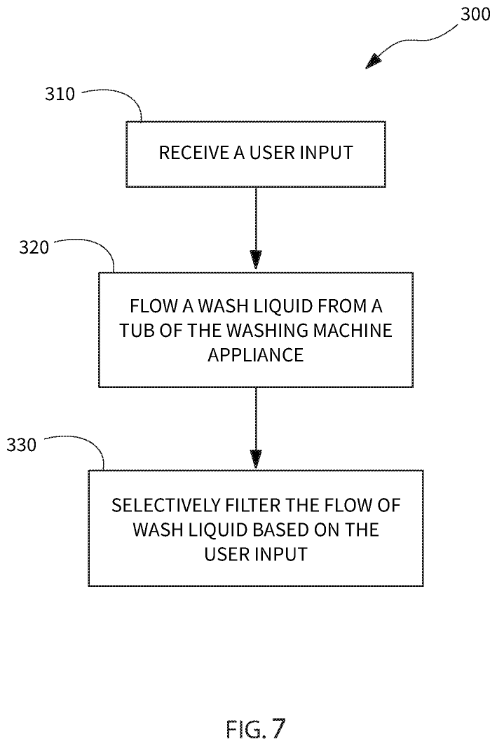

FIG. 7 illustrates another example embodiments of a method 300 of operating a washing machine appliance according to the present subject matter. Method 300 can be used to operate any suitable washing machine appliance, such as washing machine appliance 50 (FIG. 1). Method 300 may be programmed into and implemented by controller 100 (FIG. 2) of washing machine appliance 50. Utilizing method 300, controller 100 may selectively filter effluent from the washing machine appliance 50 based on a user input.

In some embodiments, the user input may be a selected cycle of the washing machine appliance. For example, the selected cycle may be a synthetics cycle or a cycle associated with a synthetic load type, e.g., an Active Wear cycle, as mentioned above. As another example, the selected cycle may be a natural fiber cycle, such as a cotton cycle, or other cycle associated with a natural load type. In some embodiments, at least a third option may be included, e.g., a blended cycle or other cycle associated with a blended load type. Thus, selectively filtering the flow of wash liquid from the tub 64 and/or wash chamber 73 therein may include filtering the flow of wash liquid when the selected cycle is associated with a synthetic load type or not filtering the flow of wash liquid when the selected cycle is associated with a natural load type. Additionally, in various embodiments where the blended load type or one or more associated cycles are included, selectively filtering the flow of wash liquid from the tub 64 and/or wash chamber 73 therein may include filtering or not filtering the flow of wash liquid based on the selected cycle when the selected cycle is associated with the blended load type.

In some embodiments, the user input may include a manual filtration input. In such embodiments, selectively filtering the flow of wash liquid at step 330 may include filtering the flow of wash liquid in response to the user input when the manual filtration input is selected or activated, and/or step 330 may include not filtering the flow of wash liquid when the manual filtration input is not selected or is deactivated.

The appliances and methods disclosed herein provide numerous advantages. For example, the appliances and methods disclosed herein may minimize or avoid unnecessary use of the filter when washing natural fiber articles. As another example, the appliances and methods disclosed herein may determine the load type without relying on specialized sensors which add both expense and complexity, such as optical sensors, e.g., near infrared sensors. Thus, the appliances and methods disclosed herein may not use or include specialized sensors to directly observe the articles in the tub or to directly detect the presence of fibers in the flow of liquid from the tub. Thus, in at least some embodiments, the method may not include using a sensor to determine the load type of the articles in the wash chamber and/or the washing machine appliance may not include a sensor for determining the load type of articles within the wash chamber. Furthermore, it should be noted that the foregoing advantages are by way of example only and are not intended to be limiting.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a washing machine appliance, the washing machine appliance having a drum positioned within a tub, the drum defining a wash chamber for receipt of articles for washing, the method comprising:
determining a load type of articles within the wash chamber of the drum based on mass of the articles and absorbency of the articles;
flowing a wash liquid from the tub; and
selectively automatically filtering the flow of wash liquid based on the determined load type.

2. The method of claim 1, wherein selectively automatically filtering the flow of wash liquid based on the determined load type comprises automatically filtering the flow of wash liquid when the determined load type is a synthetic load type.

3. The method of claim 1, wherein selectively automatically filtering the flow of wash liquid based on the determined load type comprises not automatically filtering the flow of wash liquid when the determined load type is a natural load type.

4. The method of claim 1, wherein selectively automatically filtering the flow of wash liquid based on the determined load type comprises automatically filtering the flow of wash liquid when the determined load type is a blended load type.

5. The method of claim 1, wherein selectively automatically filtering the flow of wash liquid based on the determined load type comprises not automatically filtering the flow of wash liquid when the determined load type is a blended load type.

6. The method of claim 1, further comprising filtering the flow of wash liquid in response to a user input when the flow of wash liquid is not automatically filtered.

7. The method of claim 6, wherein the user input is a selected cycle of the washing machine appliance.

8. The method of claim 6, wherein the user input is a manual filtration input.

9. The method of claim 1, wherein selectively automatically filtering the flow of wash liquid comprises actuating a diverter valve to selectively direct the flow of wash liquid to one of a filter line and a bypass line based on the determined load type.

10. The method of claim 1, further comprising directing the flow of wash liquid to a drain after selectively automatically filtering the flow of wash liquid.

11. The method of claim 1, further comprising recirculating the flow of wash liquid through the tub after selectively automatically filtering the flow of wash liquid.

12. The method of claim 1, wherein determining the load type of articles does not include using a sensor to directly observe the articles in the tub.

13. A method of operating a washing machine appliance, the washing machine appliance having a drum positioned within a tub, the drum defining a wash chamber for receipt of articles for washing, the method comprising:
receiving a user input;
flowing a wash liquid from the tub; and
selectively filtering the flow of wash liquid based on the user input.

14. The method of claim 13, wherein the user input is a selected cycle of the washing machine appliance, and wherein the step of selectively filtering the flow of wash liquid based on the user input comprises filtering the flow of wash liquid when the selected cycle is associated with a synthetic load type.

15. The method of claim 13, wherein the user input is a selected cycle of the washing machine appliance, and wherein the step of selectively filtering the flow of wash liquid based on the user input comprises not filtering the flow of wash liquid when the selected cycle is associated with a natural load type.

16. The method of claim 13, wherein the user input is a selected cycle of the washing machine appliance, and wherein the step of selectively filtering the flow of wash liquid based on the user input comprises filtering the flow of wash liquid when the selected cycle is associated with a blended load type.

17. The method of claim 13, wherein the user input is a selected cycle of the washing machine appliance, and wherein the step of selectively filtering the flow of wash liquid based on the user input comprises not filtering the flow of wash liquid when the selected cycle is associated with a blended load type.

18. The method of claim 13, wherein the user input is a manual filtration input and wherein the step of selectively filtering the flow of wash liquid based on the user input comprises filtering the flow of wash liquid in response to the manual filtration input.

19. The method of claim 13, wherein selectively filtering the flow of wash liquid comprises actuating a diverter valve downstream of the tub to selectively provide fluid communication from the tub to one of a filter line and a bypass line.
